(19) United States
(12) Patent Application Publication
(10) Pub. No.: US 2026/0046515 A1
(43) Pub. Date: Feb. 12, 2026

(54) CONTROL APPARATUS, LENS APPARATUS, IMAGE PICKUP APPARATUS, CAMERA SYSTEM, CONTROL METHOD, LENS APPARATUS, AND STORAGE MEDIUM

(71) Applicant: CANON KABUSHIKI KAISHA, Tokyo (JP)

(72) Inventor: TOMOKI TOKITA, Tochigi (JP)

(21) Appl. No.: 19/277,209

(22) Filed: Jul. 22, 2025

(30) Foreign Application Priority Data
Aug. 8, 2024 (JP) 2024-133255

(51) Int. Cl. H04N 23/67

(52) U.S. Cl. CPC H04N 23/67

(57) ABSTRACT

An apparatus for use with a camera system that includes a lens apparatus having an optical system including a focus lens unit, and a pickup apparatus having a sensor configured to acquire an image from an optical image formed by the optical system includes one or more processors that operate to acquire a plurality of pieces of distortion information for correction processing to distortion caused by the optical system in the image, and perform the correction processing using first distortion information among the plurality of pieces of distortion information for correction processing to distortion of an image of an out-of-focus object.

### BACKGROUND

### Field of the Technology

The aspect of the disclosure relates to one or more embodiments of a control apparatus, a lens apparatus, an image pickup apparatus, a camera system, a control method, a lens apparatus, and a storage medium.

### Description of the Related Art

In some imaging optical systems, when a focus lens unit is moved to adjust an object distance to be focused, angle-of-view fluctuation (focus breathing) may occur according to the position of the focus lens unit. Japanese Patent Application Laid-Open No. 2007-142965 discloses a configuration for correcting focus breathing by converting the size of an image based on the imaging magnification at each position of the focus lens unit.

Moving the focus lens unit also fluctuates distortion generated in the imaging optical system. Japanese Patent Application Laid-Open No. 2019-208168 discloses a configuration for correcting focus breathing based on distortion correction that electronically corrects distortion (Japanese Patent Application Laid-Open No. 2019-208168).

### SUMMARY

One or more embodiments of an apparatus according to one or more aspects of the embodiments for use with a camera system that includes a lens apparatus having an optical system including a focus lens unit, and a pickup apparatus having a sensor configured to acquire an image from an optical image formed by the optical system may include one or more processors that operate to acquire a plurality of pieces of distortion information for correction processing to distortion caused by the optical system in the image, and perform the correction processing using first distortion information among the plurality of pieces of distortion information for correction processing to distortion of an image of an out-of-focus object. One or more lens apparatuses may include one or more apparatuses in accordance with one or more other aspects of the embodiments. One or more pickup apparatuses may include one or more apparatuses in accordance with one or more other aspects of the embodiments. One or more camera systems may include one or more apparatuses in accordance with one or more other aspects of the embodiments. One or more methods corresponding to the above one or more apparatuses also constitute another aspect of the embodiments. A storage medium storing a program that causes a computer to execute the above one or more methods also constitutes another aspect of the embodiments.

One or more embodiments of a lens apparatus according to one or more aspects of the disclosure may include an optical system including a focus lens unit, and a memory storing information on distortion of an image of an out-of-focus object of the optical system. One or more embodiments of an apparatus according to one or more aspects of the disclosure configured to correct breathing that occurs in an optical system including a focus lens unit may include one or more memories storing instructions, and one or more processors that, upon execution of the instructions, operate to correct breathing based on information on distortion of an image of an out-of-focus object of the optical system.

Features of the disclosure will become apparent from the following description of embodiments with reference to the attached drawings. The following description of embodiments is described by way of example.

### BRIEF DESCRIPTION OF THE DRAWINGS

FIG. 1 is a schematic diagram of a camera system according to this embodiment of the disclosure.

FIG. 2 illustrates an example of distortion information.

FIG. 3 illustrates an example of enlargement ratio (or factor) information.

FIGS. 4A and 4B are schematic diagrams of focusing distortion fluctuation correction.

FIG. 5 illustrates an example of a result of focusing distortion fluctuation correction.

FIG. 6 is a flowchart illustrating the correction processing according to a first embodiment.

FIG. 7 is a flowchart illustrating the correction processing according to a second embodiment.

FIG. 8 is a flowchart illustrating the correction processing according to a third embodiment.

FIG. 9 is a schematic diagram of a captured scene, an input image, and distortion (prior art).

FIGS. 10A and 10B are schematic diagrams of focusing distortion fluctuation (prior art).

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

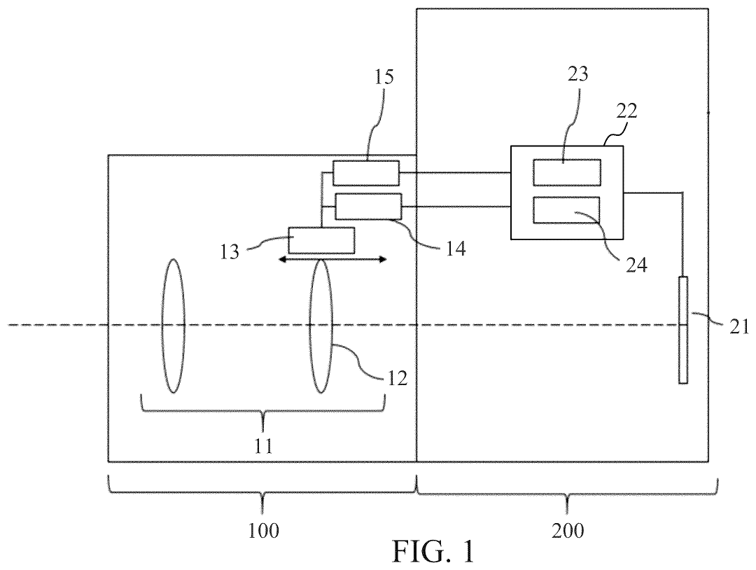

FIG. 1 is a schematic diagram of a camera system according to this embodiment of the disclosure. The camera system includes a lens apparatus 100 and a camera (image pickup apparatus) 200. The camera system is, for example, a digital video camera, a digital still camera, a broadcasting camera, and a surveillance camera. The lens apparatus 100 may be attachable to and detachable from the camera 200, or may be integrated with the camera 200.

The lens apparatus 100 includes an imaging optical system 11, a focus position detector 13, a distortion correction information memory 14, and a (focus) breathing correction information memory 15. The imaging optical system 11 includes a focus lens unit 12. Moving the focus lens unit 12 changes an in-focus object distance within a drive range from a close distance to infinity. The focus lens unit 12 may be provided in a plurality of lens units, for example, floating focus. The focus position detector 13 detects the in-focus position of the focus lens unit 12. The distortion correction information memory 14 stores a plurality of pieces of distortion information that differ for each image height and are used for correction processing (distortion correction) of distortion generated by the imaging optical system 11 to an input image obtained by imaging. In this embodiment, the plurality of pieces of distortion information include distortion information (first distortion information) that is used for distortion correction to an optical image of an out-of-focus object formed by the imaging optical system 11 according to the position of the focus lens unit 12. The distortion information is transmitted to the camera 200. The breathing correction information memory 15 stores enlargement ratio information for enlarging the input image. The enlargement ratio information is transmitted to the camera 200. Thereby, distortion and focus breathing of a variety of lenses, including types and manufacturing errors, can be corrected.

The enlargement ratio information corresponds to the distortion information. More specifically, the enlargement ratio information and distortion information may be set so that a corrected image is obtained by performing both the corresponding distortion correction and enlargement processing. Proper enlargement ratio information according to the distortion information may be used, because it suppresses an uncorrected focus breathing amount (residue).

Two or more types of distortion information may be provided for each position of the focus lens unit 12. The user can separately select a distortion correction value between an imaging condition in which the focusing distortion fluctuation is likely to stand out and an imaging condition in which the focusing distortion fluctuation is not likely to stand out.

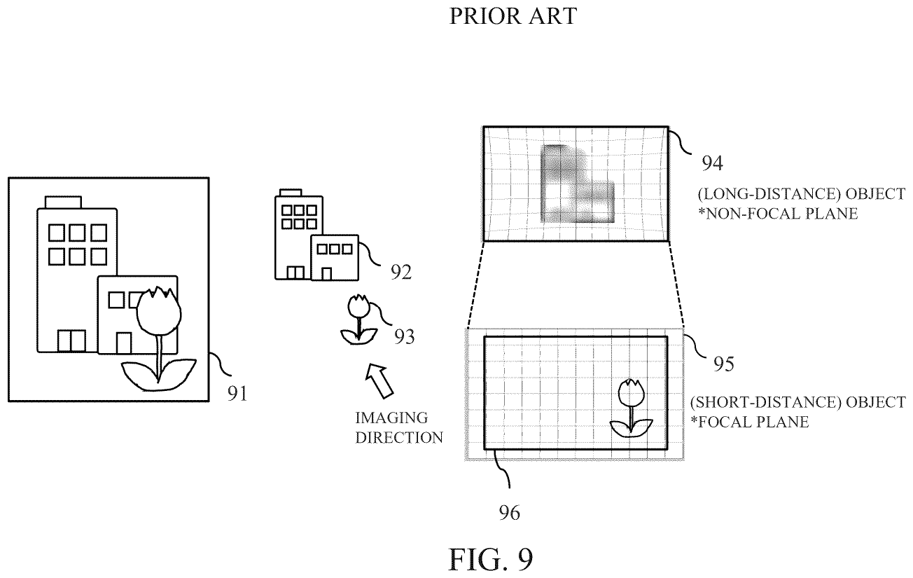

A description will now be given of the “focusing distortion fluctuation (distortion fluctuation during focusing),” which is an issue that the disclosure attempts to solve. FIG. 9 illustrates an input image 91 obtained by imaging a long-distance object 92 and a short-distance object 93, and the distortion states 94 and 95 of these optical images. A thick frame 96 indicates an enlarged range after focus breathing is corrected. Usually, a distance between a variety of objects and the image pickup apparatus in one frame of a captured moving image is not constant, and an in-focus object and an out-of-focus object exist within the same frame. The distortion correction values of the optical images for the in-focus and out-of-focus objects are different, and in a case where the distortion of the optical image of the out-of-focus object is corrected using the distortion correction value of the optical image of the in-focus object as in the configuration of Japanese Patent Application Laid-Open No. 2019-208168, for example, some distortion remains uncorrected.

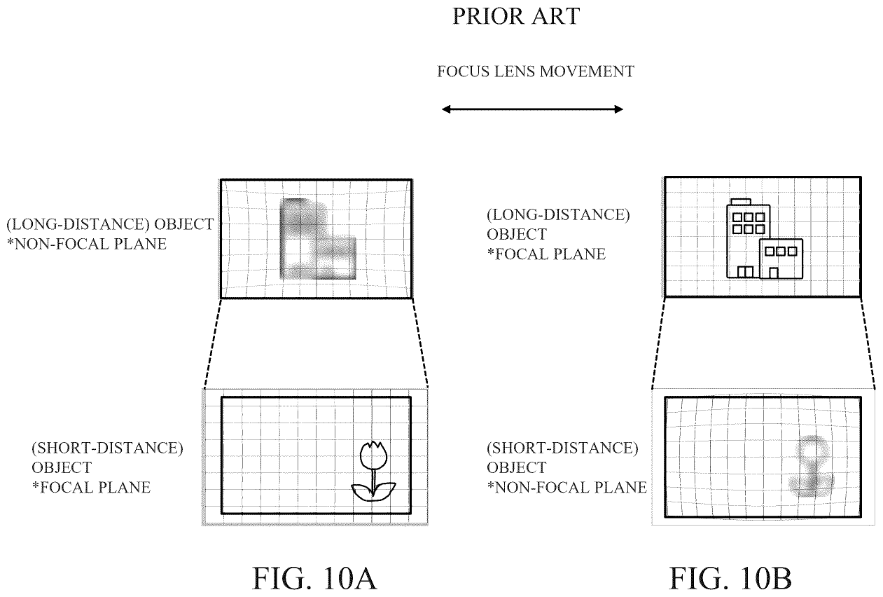

In particular, in a case where a distortion difference is large, moving the focus lens unit to adjust the object distance causes an uncorrected distortion amount to fluctuate, and generates focusing distortion fluctuation, which fluctuates a distortion amount in an image (screen) during moving image capturing. FIGS. 10A and 10B are schematic diagrams of the focusing distortion fluctuation. FIGS. 10A and 10B illustrate the distortion states in a case where a short-distance object and a long-distance object are in focus, respectively. It is difficult to correct focusing distortion fluctuation using focus breathing correction alone, and the moving-image quality may deteriorate.

For example, the distortion information may be switched to a different type between moving image capturing in which the focusing distortion fluctuation is likely to stand out and still image capturing in which the focusing distortion fluctuation is less likely to stand out than moving image capturing. In a case where an imaging object distance is uniform, optimal distortion correction can be applied to an in-focus object distance by turning off the focusing distortion fluctuation correction, which will be described later.

The camera 200 includes an image sensor 21 and a control unit (control apparatus) 22. The image sensor 21 converts an optical image formed by the imaging optical system 11 into a digital signal. The control unit 22 includes an acquiring unit 23 and a corrector 24. The acquiring unit 23 acquires a plurality of pieces of distortion information from the distortion correction information memory 14 and acquires enlargement ratio information from the breathing correction information memory 15. The corrector 24 corrects distortion in the input image formed by the image sensor 21 using distortion information selected from among the plurality of pieces of distortion information. In this embodiment, the corrector 24 corrects distortion using distortion information that is used for distortion correction on an optical image of an out-of-focus object according to the position of the focus lens unit 12. A zoom position and aperture state are arbitrary. Thereby, an uncorrected amount can be most effectively reduced in a case where an object plane on which focusing distortion fluctuation is to be corrected is not in an in-focus state, as described below. The corrector 24 also corrects focus breathing using enlargement ratio information. The corrector 24 may also be configured as a means for performing distortion correction processing and a means for performing focus breathing correction processing.

In this embodiment, the control unit 22 is provided in the camera 200, but it may be provided in the lens apparatus 100, or may be configured as a control apparatus different from the camera system.

The corrector 24 determines the shape of distortion from an input image, and if the input image has pincushion distortion, it changes the enlargement ratio information according to the enlargement ratio to correct the pincushion-shaped distortion. Thereby, even the pincushion distortion can be properly corrected.

In correcting distortion using distortion information of an optical image of an out-of-focus object, the position of the focus lens unit 12 may not be a position that is in focus on the closest object within a movable range. As will be described later, with the lens specifications that are likely to cause focusing distortion fluctuation, distant objects often occupy a large proportion of the entire screen. Thus, distortion may be corrected in the entire focus range that is tailored to objects other than the closest object plane. The position at which the closest object is in focus includes not only a position at which the closest object is strictly in focus, but also a position near the position at which the closest object is in focus (a position at which the closest object is substantially in focus).

The distortion information may include distortion information (second distortion information) that is used to correct distortion of an optical image of an in-focus object. In a case where the user selects a distortion correction value, distortion correction using information for correcting distortion related to an object to be focused most effectively reduces the uncorrected amount.

The control unit 22 may include a distance map information calculator and an object area information calculator. The distance map information calculator acquires distance map information to an object for each of a plurality of areas of an input image using defocus information obtained from the camera 200. The method of obtaining the distance map information can be replaced with a known arbitrary means (e.g., the TOF method, etc.). The object area information calculator obtains ratio information (object area information) regarding the proportion of the object area to the overall area of the input image based on the distance map information. The corrector 24 may perform distortion correction processing for an input image using distortion information according to the object area information calculated by the object area information calculator. The distance map information may be updated for each frame during moving image capturing, and the object area information may also be updated. Since an object captured during moving image capturing changes from time to time, it is possible to apply distortion information suitable for that frame by updating the object area information for each frame.

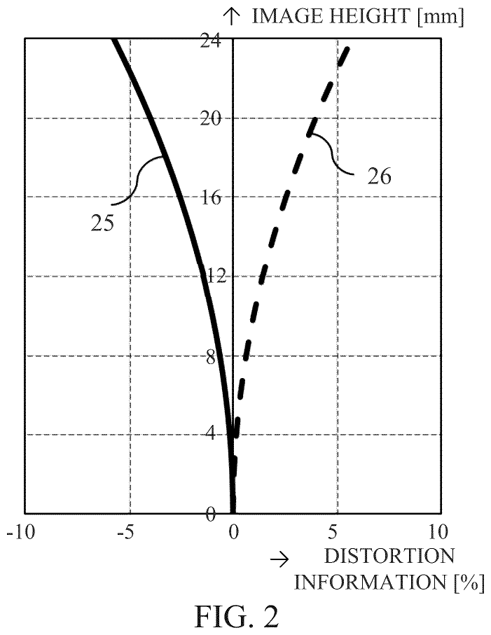

FIG. 2 illustrates an example of distortion information stored in the distortion correction information memory 14, illustrating distortion information at an arbitrary zoom position and object distance. The vertical axis illustrates image height, and the horizontal axis illustrates distortion information. A solid line 25 illustrates an example of distortion information of negative distortion (barrel distortion), and a broken line 26 illustrates an example of distortion information of positive distortion (pincushion distortion). The corrector 24 corrects distortion to reduce distortion based on the distortion information.

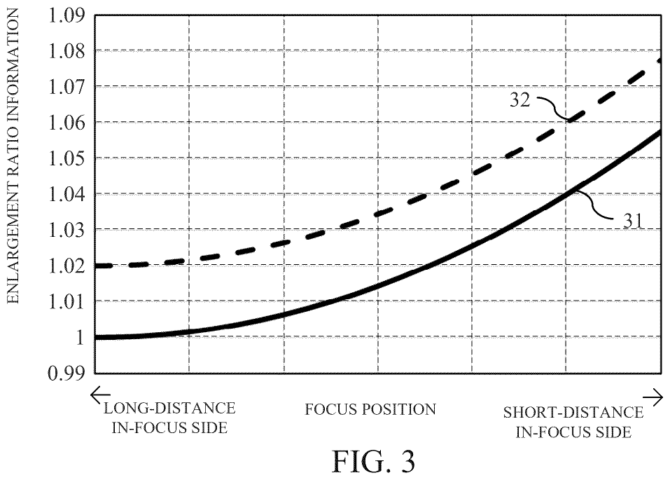

FIG. 3 illustrates an example of enlargement ratio information stored in the breathing correction information memory 15, and illustrates the enlargement ratio information at an arbitrary zoom position. The vertical axis illustrates the enlargement ratio information, and the horizontal axis illustrates the position of the focus lens unit. A solid line 31 illustrates an example of enlargement ratio information in a case where a peripheral light amount (light amount in an area with an image height of 90% or more) of an input image is 10% or more, and a broken line 32 illustrates an example of enlargement ratio information in a case where the peripheral light amount of the input image is less than 10%. The corrector 24 performs correction based on the enlargement ratio information to reduce focus breathing. In a case where the peripheral light amount of the input image is less than 10%, a natural image having no dark periphery can be obtained by performing enlargement processing using enlargement ratio information set so that the enlargement ratio β satisfies inequality (1) described later over the entire focus area as illustrated by the broken line 32.

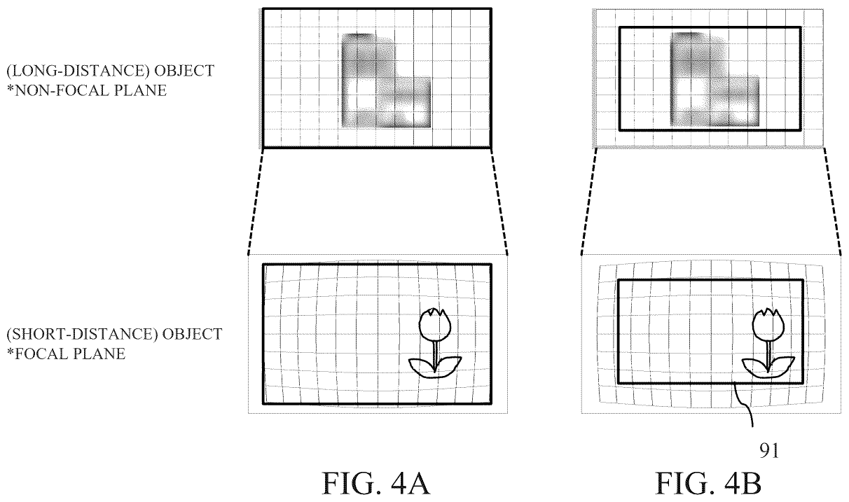

Here, a supplementary explanation will be given on distortion information. FIGS. 4A and 4B are schematic diagrams of focusing distortion fluctuation correction. In order to suppress focusing distortion fluctuation, a distortion correction value is set so that distortion at a predetermined object distance (in many cases, a long-distance object) is corrected over the entire focus range. For example, as illustrated in FIG. 4A, distortion of an object at infinity (or a long-distance object at a finite distance) is corrected regardless of the position of the focus lens unit 12 in the moving range. This configuration can correct distortion of a long-distance object, which occupies most of the output image, regardless of whether the object is in focus or not. This correction will be referred to as focusing distortion fluctuation correction hereinafter.

The distortion information for focusing distortion fluctuation correction can be generated by arbitrarily setting an object distance at which an uncorrected distortion amount is to be minimized. In many cases, in a wider-angle lens, a distortion difference between an in-focus object and an out-of-focus object increases. Therefore, in a case where an object captured with a wide-angle lens is considered, an object distance at which an uncorrected amount is minimized may be long. On the other hand, an uncorrected amount exists to some extent other than the set object distance, but since an imaging distance of an object that occupies a large proportion of the image depends to some extent on the lens specification, image quality degradation caused by the uncorrected amount can be suppressed by setting the distortion correction value according to the lens specification.

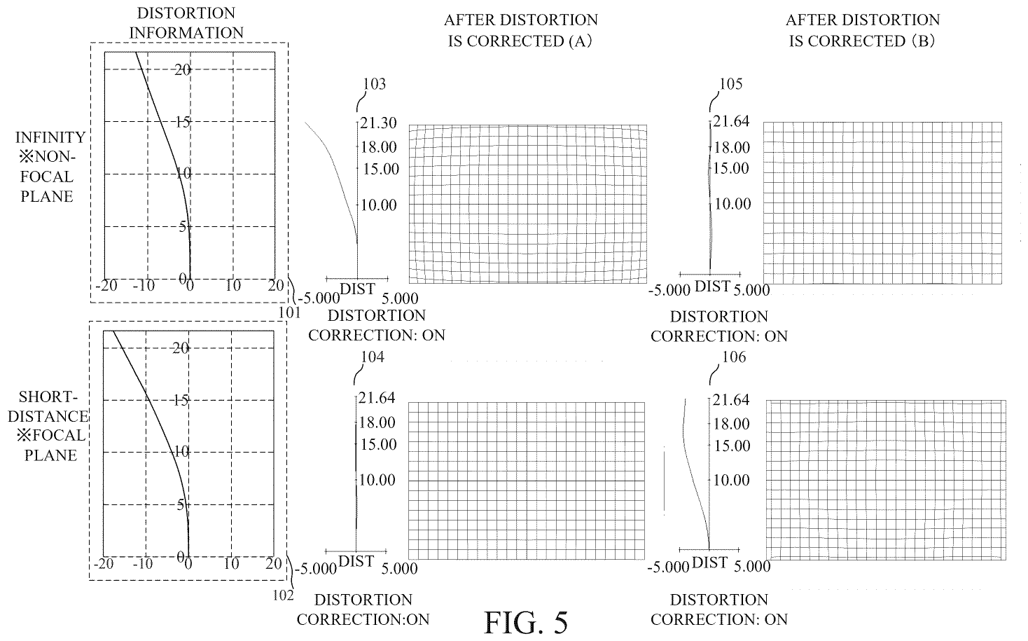

FIG. 5 illustrates an example of a result of focusing distortion fluctuation correction. Reference numerals 101 and 102 respectively denote distortion information for an object at infinity and a short-distance object in a case where the focus lens unit 12 is positioned so that the short-distance object is in focus. Reference numerals 103 and 104 respectively indicate uncorrected amounts in a case where distortion correction (A) using the distortion information 102 is performed for distortions of the object at infinity and the short-distance object so as to correct the distortion of the short-distance object which is a focal plane. Reference numerals 105 and 106 respectively indicate uncorrected amounts in a case where distortion correction (B) using the distortion information 101 is performed for distortions of the object at infinity and the short-distance object so as to correct the distortion of the object at infinity, which is a non-focal plane. The distortion correction (B) corresponds to focusing distortion fluctuation correction, and correcting distortion of an optical image of an out-of-focus object over the entire focus range can highly accurately correct the image point movement after focus breathing is corrected.

As described above, the configuration according to this embodiment can provide a more natural image while suppressing the image point movement along with the movement of the focus lens unit.

In the focus breathing correction, in a case where a minimum value V1min of a peripheral light amount of an input image is less than 10%, the enlargement ratio information may be set so that a enlargement ratio β for the enlargement processing satisfies the following inequality (1) over the entire focus range:

$$1. < β < 2.0 \qquad ( 1 )$$

A description will now be given of the definition of the enlargement ratio β. In an input image obtained when the focus lens unit 12 is located at a predetermined position, Yn is a distance AO between the position of an image point A located at a diagonal outermost periphery that provides a predetermined angle of view and an image center O. Ymin is a distance AO that provides the narrowest angle of view in the entire focus range. At this time, the enlargement ratio β when the focus lens unit 12 is located at a predetermined position is defined by the following equation (1-1):

$$β = Yn / Ymin \qquad ( 1 - 1 )$$

One of the issues that arise in the focusing distortion fluctuation correction is that a peripheral light amount decreases at a focus position where there is an uncorrected distortion amount (especially barrel distortion). FIG. 4B is a schematic diagram of a solution for this problem. In a case where the minimum value V1min of the peripheral light amount of the input image is smaller than 10%, setting the enlargement ratio information so that the enlargement ratio β satisfies inequality (1) over the entire focus range can provide a natural image having no dark periphery in the focusing distortion fluctuation correction and focus breathing correction. In a case where the enlargement ratio β becomes lower than the lower limit of inequality (1), the peripheral light amount decreases in the focus breathing correction, and it becomes difficult to obtain a natural image. In a case where the enlargement ratio β becomes higher than the upper limit of inequality (1), the image quality of the input image deteriorates significantly.

The enlargement ratio information may be set so that the minimum value V2min of the peripheral light amount of the corrected image obtained by performing the distortion correction processing and enlargement processing for the input image satisfies the following inequality (2):

$$10 \leq V 2 min \leq 100 \qquad ( 2 )$$

Satisfying inequality (2) can provide a natural image after focus breathing is corrected. In a case where the minimum value V2min becomes lower than the lower limit of inequality (2), the peripheral light amount after the focus breathing correction decreases, and it becomes difficult to provide a natural image.

The following inequality (3) may be satisfied:

$$1. < β max / β min < 2.00 \qquad ( 3 )$$

where βmax and βmin are a maximum value and a minimum value of the enlargement ratio β of the enlargement processing in the entire focus range, respectively. Satisfying inequality (3) can effectively suppress angle-of-view fluctuation in the focus breathing correction. In a case where βmax/βmin becomes lower than the lower limit of inequality (3), it is difficult to suppress angle-of-view fluctuation. In a case where βmax/βmin becomes higher than the upper limit of inequality (3), the image quality of the input image will be significantly degraded.

Inequalities (1) to (3) may be replaced with inequalities (1a) to (3a) below, respectively:

$$1. < β < 1.7 \qquad ( 1 a )$$

$$15 \leq V2 min \leq 1 \; 00 \qquad ( 2 a )$$

$$1. < βmax / βmin < 1.7 \qquad ( 3 a )$$

Inequalities (1) to (3) may be replaced with inequalities (1b) to (3b) below, respectively:

$$1. < β < 1.6 \qquad ( 1 b )$$

$$20 \leq V 2 min \leq 100 \qquad ( 2 b )$$

$$1. 00 < βmax / βmin < 1.6 \qquad ( 3 b )$$

A description will now be given of correction processing according to each embodiment.

### First Embodiment

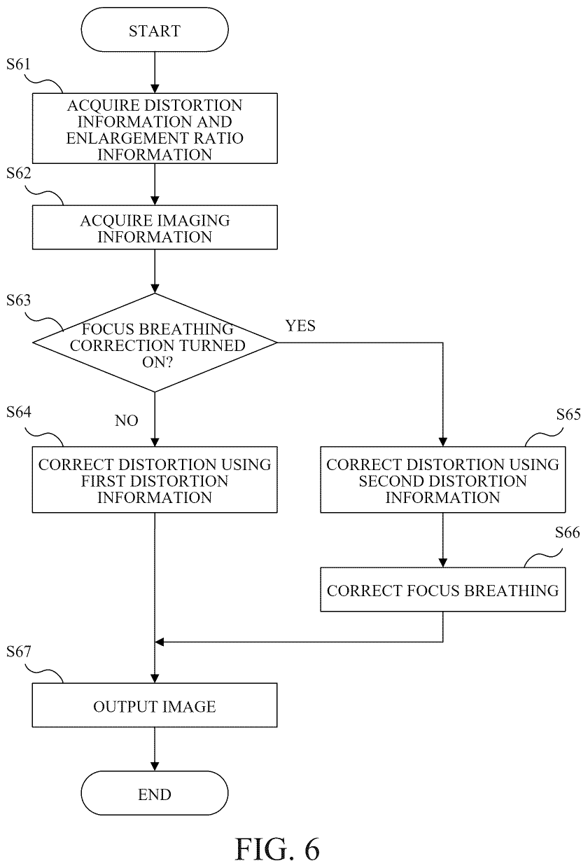

FIG. 6 is a flowchart illustrating correction processing according to this embodiment. This flow starts by powering on the camera 200. In step S61, the acquiring unit 23 acquires distortion information and enlargement ratio information from the lens apparatus 100. In step S62, the control unit 22 causes the camera 200 to acquire an image and acquires imaging information. In step S63, the control unit 22 determines whether focus breathing correction is turned on in the imaging information (whether the setting is set to correct focus breathing). In a case where the control unit 22 determines that focus breathing correction is turned on, the flow proceeds to step S65, and in a case where it determines that focus breathing correction is not turned on, the flow proceeds to step S64. In step S64, the corrector 24 performs distortion correction using the first distortion information. The first distortion information is distortion information for correcting distortion related to an in-focus object in the entire focus range. In step S65, the corrector 24 performs distortion correction using the second distortion information. The second distortion information is distortion information for correcting distortion related to an object at infinity in the entire focus range, and also includes distortion information for correcting distortion related to an out-of-focus object. In step S66, the corrector 24 corrects focus breathing using the enlargement ratio information. In step S67, the control unit 22 causes an image to be output. The output image may be stored in a recording medium or displayed on a display device such as an external output monitor.

### Second Embodiment

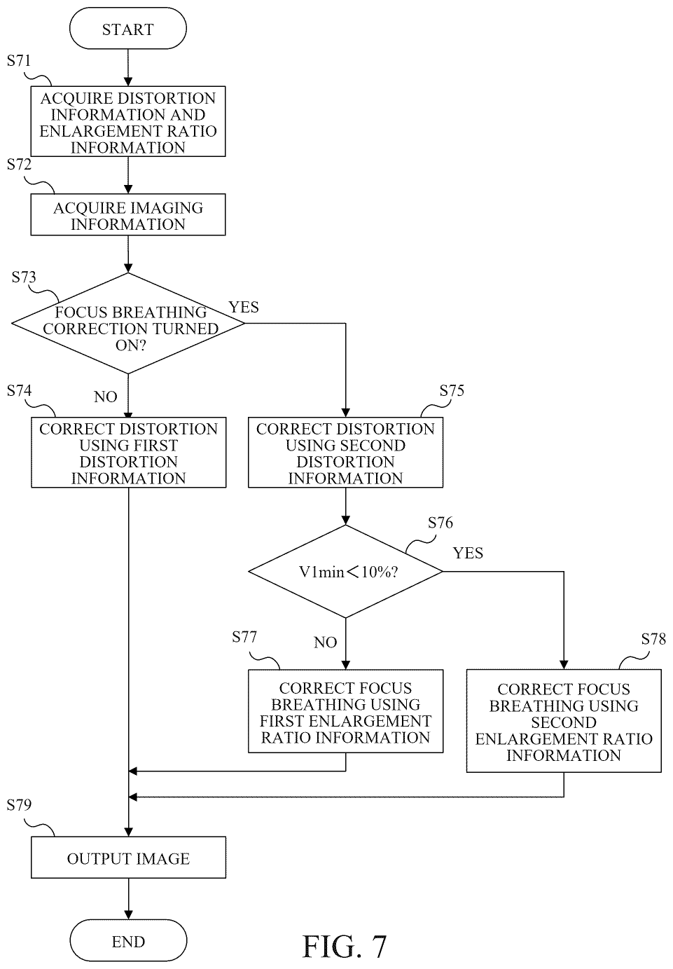

FIG. 7 is a flowchart illustrating correction processing according to this embodiment. This flow is started by powering on the camera 200. In step S71, the acquiring unit 23 acquires distortion information and enlargement ratio information from the lens apparatus 100. In step S72, the control unit 22 causes the camera 200 to acquire an image and acquires imaging information. In step S73, the control unit 22 determines whether focus breathing correction is turned on in the imaging information. In a case where the control unit 22 determines that focus breathing correction is turned on, the flow proceeds to step S75, and in a case where it determines that focus breathing correction is not turned on, the flow proceeds to step S74. In step S74, the corrector 24 executes distortion correction using the first distortion information. The first distortion information is distortion information for correcting distortion related to an in-focus object in the entire focus range. In step S75, the corrector 24 executes distortion correction using the distortion information. The second distortion information is distortion information for correcting distortion related to an object at infinity in the entire focus range, and also includes distortion information for correcting distortion related to an out-of-focus object. In step S76, the control unit 22 determines whether the minimum value V1min of the peripheral light amount of the input image is less than 10%. In a case where the control unit 22 determines that the minimum value V1min of the peripheral light amount of the input image is less than 10%, the flow proceeds to step S78, and in a case where it determines that the minimum value VImin of the peripheral light amount of the input image is not less than 10%, the flow proceeds to step S77. In step S77, the corrector 24 corrects focus breathing using the first enlargement ratio information. In step S78, the corrector 24 corrects focus breathing using the second enlargement ratio information. The second enlargement ratio information is set so that the enlargement ratio β satisfies inequality (1) over the entire focus range. In step S79, the control unit 22 outputs the image. The output image may be stored in a recording medium or may be displayed on a display device such as an external output monitor.

### Third Embodiment

Unlike the first and second embodiments, this embodiment has two correction modes A and B. The correction mode A is a mode for correcting distortion related to an object at infinitely over the entire focusing range, similarly to the first and second embodiments. The correction mode B is a mode for correcting distortion relating to an object at a predetermined finite distance.

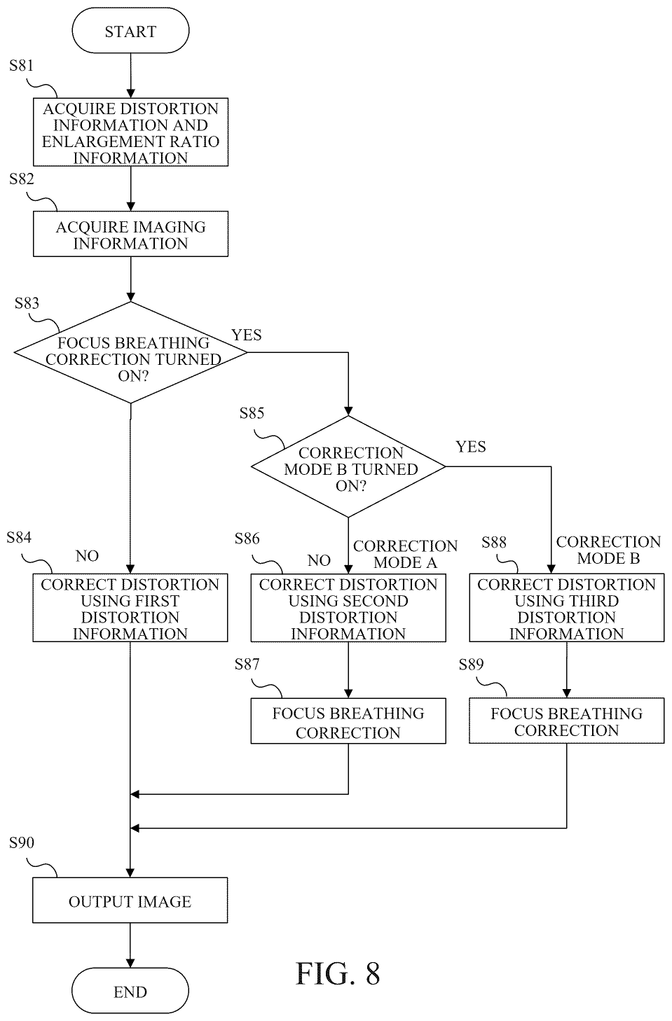

FIG. 8 is a flowchart illustrating correction processing according to this embodiment. This flow is started by powering on the camera 200. In step S81, the acquiring unit 23 acquires distortion information and enlargement ratio information from the lens apparatus 100. In step S82, the control unit 22 causes the camera 200 to acquire an image and acquires imaging information. In step S83, the control unit 22 determines whether focus breathing correction is turned on in the imaging information. In a case where the control unit 22 determines that focus breathing correction is turned on, the flow proceeds to step S85, and in a case where it determines that focus breathing correction is not turned on, the flow proceeds to step S84. In step S84, the corrector 24 executes distortion correction using the first distortion information. The first distortion information is distortion information for correcting distortion related to the in-focus object in the entire focus range. In step S85, the control unit 22 determines whether the setting of the correction mode B is turned on. In a case where the control unit 22 determines that the setting of the correction mode B is turned on, the flow proceeds to step S88, and in a case where it determines that the setting of the correction mode B is not turned on, the flow proceeds to step S86. In step S86, the corrector 24 executes distortion correction using the second distortion information. The second distortion information is distortion information for correcting distortion related to an object at infinity in the entire focus range, and also includes distortion information for correcting distortion related to an out-of-focus object. In step S87, the corrector 24 corrects focus breathing using the enlargement ratio information. In step S88, the corrector 24 executes distortion correction using the third distortion information. The third distortion information is distortion information for correcting distortion related to an object at a predetermined finite distance in the entire focus range, and also includes distortion information for correcting distortion related to an out-of-focus object. In step S89, the corrector 24 corrects focus breathing using the enlargement ratio information. In step S90, the control unit 22 causes the image to be output. The output image may be stored in a recording medium, or may be displayed on a display device such as an external output monitor.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions. For example, the disclosure may be directed to a lens apparatus that includes an imaging optical system including a focus lens unit, and a memory storing information on distortion of an optical image of an out-of-focus object of the imaging optical system. In addition, the disclosure may be directed to a control apparatus configured to correct breathing that occurs in an imaging optical system including a focus lens unit and including one or more memories storing instructions, and one or more processors that, upon execution of the instructions, operate to correct breathing based on information on distortion of an optical image of an out-of-focus object of the imaging optical system.

Each embodiment can provide a control apparatus that can provide a more natural image while suppressing image point movement along with movement of a focus lens unit.

This application claims the benefit of Japanese Patent Application No. 2024-133255, which was filed on Aug. 8, 2024, and which is hereby incorporated by reference herein in its entirety.

What is claimed is:

1. An apparatus for use with a camera system that includes a lens apparatus having an optical system including a focus lens unit, and a pickup apparatus having a sensor configured to acquire an image from an image formed by the optical system, the apparatus comprising:
one or more memories storing instructions; and
one or more processors that, upon execution of the instructions, operate to:
acquire a plurality of pieces of distortion information for correction processing to distortion caused by the optical system in the image, and
perform the correction processing using first distortion information among the plurality of pieces of distortion information for correction processing to distortion of an image of an out-of-focus object.

2. The apparatus according to claim 1, wherein the one or more processors operate to:
acquire enlargement ratio information for enlargement processing to the image that has received the correction processing, and
perform the enlargement processing using the enlargement ratio information.

3. The apparatus according to claim 2, wherein the following inequality is satisfied:
$$1. < β max / β min < 2.00$$
where βmax is a maximum value of a enlargement ratio of the enlargement processing in an entire focus area included in the enlargement ratio information, and βmin is a minimum value of the enlargement ratio.

4. The apparatus according to claim 2, wherein the one or more processors operate to:
acquire a plurality of pieces of enlargement ratio information for the enlargement processing to the image that has received the correction processing, each of which corresponds to one of the plurality of pieces of distortion information, and
perform, after the correction processing using the first distortion information is performed, the enlargement processing using enlargement ratio information corresponding to the first distortion information.

5. The apparatus according to claim 1, wherein a position of the focus lens unit when the correction processing is performed using the first distortion information is not a position of the focus lens unit that is in focus on a closest object within a movable range.

6. The apparatus according to claim 1, wherein the one or more processors operate to acquire a plurality of pieces of first distortion information for each position of the focus lens unit.

7. The apparatus according to claim 6, wherein the first distortion information for moving image capturing is different from the first distortion information for still image capturing.

8. The apparatus according to claim 1, wherein the plurality of distortion information include second distortion information for distortion correction processing to an optical image of an in-focus object.

9. The apparatus according to claim 2, wherein the one or more processors operate to:
change the enlargement ratio information in a case where the image has pincushion distortion, and
perform the enlargement processing using changed enlargement ratio information.

10. The apparatus according to claim 2, wherein the one or more processors operate to perform the enlargement processing using the enlargement ratio information according to fluctuation in a position of the focus lens unit during moving image capturing.

11. The apparatus according to claim 2, wherein in a case where the minimum value of a peripheral light amount of the image is less than 10%, the one or more processors operate to acquire the enlargement ratio information set so that a enlargement ratio β for the enlargement processing satisfies the following inequality over an entire focus range:
$$1. < β < 2.0 .$$

12. The apparatus according to claim 2, wherein the one or more processors operate to acquire the enlargement ratio information set so that a minimum value V2min [%] of a peripheral light amount of the image that has received the correction processing and the enlargement processing satisfies the following inequality:
$$10 \leq V 2 min \leq 100 .$$

13. The apparatus according to claim 1, wherein the plurality of pieces of distortion information are different for each image height.

14. The apparatus according to claim 1, wherein the one or more processors operate to:
acquire ratio information on a ratio of an area of an object to an overall area of the image based on distance map information to the object for each of a plurality of areas of the image, and
perform the correction processing using the distortion information corresponding to the ratio information.

15. A lens apparatus comprising:
the apparatus according to claim 1; and
the optical system.

16. A pickup apparatus comprising:
the apparatus according to claim 1; and
the sensor.

17. A camera system comprising:
the apparatus according to claim 1;
the optical system; and
the sensor.

18. A method for use with a camera system that includes a lens apparatus having an optical system including a focus lens unit, and a pickup apparatus having a sensor configured to acquire an image from an optical image formed by the optical system, the method comprising:
acquiring a plurality of pieces of distortion information for correction processing to distortion caused by the optical system in the image; and
performing the correction processing using first distortion information among the plurality of pieces of distortion information for correction processing to distortion of an image of an out-of-focus object.

19. A non-transitory computer-readable storage medium storing a program that causes a computer to execute the method according to claim 18.

20. A lens apparatus comprising:
an optical system including a focus lens unit; and
a memory storing information on distortion of an image of an out-of-focus object of the optical system.

21. A apparatus configured to correct breathing that occurs in an optical system including a focus lens unit, the apparatus comprising:
one or more memories storing instructions; and
one or more processors that, upon execution of the instructions, operate to correct breathing based on information on distortion of an image of an out-of-focus object of the optical system.
